(19) United States
(12) Patent Application Publication
(10) Pub. No.: US 2022/0019229 A1
(43) Pub. Date: Jan. 20, 2022

(54) FACILITATING AUTONOMOUSLY LINKING THE MOVEMENT OF OBJECTS IN FOUR DIMENSIONS IN ADVANCED NETWORKS

(71) Applicants: AT&T Intellectual Property I, L.P., Atlanta, GA (US); AT&T Global Network Services Slovakia, Bratislava (SK)

(72) Inventors: Craig Klein, San Antonio, TX (US); Gregory Harp, Allen, TX (US); Yeeling Lam, Bridgeton, MO (US); Mahendra Kuncham, Plano, TX (US); Barton K. Hawkins, San Antonio, TX (US); Filip Benuska, Rovinka (SK)

(21) Appl. No.: 16/929,681

(22) Filed: Jul. 15, 2020

(51) Int. Cl. G05D 1/02; G06N 20/00; G01C 21/34

(52) U.S. Cl. CPC G05D 1/0217; G06N 20/00; B60W 60/0023; G05D 1/0285; G01C 21/3469

(57) ABSTRACT

Facilitating autonomously linking movement of objects in four dimensions in advanced networks (e.g., 5G, 6G, and beyond) is provided herein. Operations of a method can include identifying, by a system comprising a memory and a processor, a first portion of a first traversal route grid associated with a first object and a second portion of a second traversal route grid associated with a second object. The identifying can be based on the first portion and the second portion being determined to be overlapping portions during a same time period. The method also can include linking, by the system, during the same time period, a first movement of the first object and a second movement of the second object across the overlapping portions.

### TECHNICAL FIELD

This disclosure relates generally to managing movement of objects in Fifth Generation (5G), Sixth Generation (6G), or other advanced networks and, more specifically, to an autonomously linking movement of objects in four dimensions.

### BACKGROUND

The use of computing devices is ubiquitous. These computing devices include radios and antenna elements, which allow the computing devices to communicate with other devices, as well as to access various communications networks (e.g., cellphone network, internet network, satellite network, and so on). Further, many devices have the capability of movement and/or the capability to move other devices and/or objects. Unique challenges exist to provide real-time and coordinated movement of such devices and/or objects and in view of forthcoming 5G, 6G, or other next generation, standards for wireless communication.

### BRIEF DESCRIPTION OF THE DRAWINGS

Various non-limiting embodiments are further described with reference to the accompanying drawings in which:

FIG. 1 illustrates an example, non-limiting, system that facilitates autonomously linking movement of objects in four dimensions in accordance with one or more embodiments described herein;

FIG. 2 illustrates an example, non-limiting, system that facilitates moving two or more objects as a single unit based on the two or more objects traversing a route segment at a same time in accordance with one or more embodiments described herein;

FIG. 3 illustrates an example, non-limiting, system that facilitates assigning values to a multitude of virtual paths for moving multiple objects as a single unit in accordance with one or more embodiments described herein;

FIG. 4 illustrates an example, non-limiting, system that employs automated learning to facilitate one or more of the disclosed aspects in accordance with one or more embodiments described herein;

FIG. 5 illustrates an example, non-limiting, system that facilitates linking of objects in accordance with one or more embodiments described herein;

FIG. 6 illustrates an example, non-limiting, system that facilitates moving multiple objects as a single unit in accordance with one or more embodiments described herein;

FIG. 7 illustrates a flow diagram of an example, non-limiting, computer-implemented method for facilitating autonomous linking of movement of one or more objects in advanced networks in accordance with one or more embodiments described herein;

FIG. 8 illustrates a flow diagram of an example, non-limiting, computer-implemented method for determining two or more objects should be linked such that the two or more objects are treated as a single unit during movement of the two or more objects in accordance with one or more embodiments described herein;

FIG. 9 illustrates a flow diagram of an example, non-limiting, computer-implemented method for selecting between alternative routes in accordance with one or more embodiments described herein;

FIG. 10 illustrates an example block diagram of a non-limiting embodiment of a mobile network platform in accordance with various aspects described herein; and

FIG. 11 illustrates an example block diagram of an example computer operable to engage in a system architecture that facilitates wireless communications according to one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular networked environment or standard).

Described herein are systems, methods, articles of manufacture, and other embodiments or implementations that can facilitate autonomously linking the movement of objects in four dimensions in advanced networks. For example, in a world of autonomous objects that move through space (latitude, longitude, altitude, time), the ability to link objects that are moving together autonomously to a virtual group (train, flock, and so on) to enhance the flow of objects and reduce energy consumption is provided herein. Traditionally, moving objects are treated in a singular manner, and if linked, are treated as many singular objects versus one combined object moving synchronously. The disclosed aspects provide for the linkage of moving objects into a singular object with multiple subcomponents. Further, the linkage can autonomously adjust as moving objects join and disjoin the group. For example, the disclosed aspects can enable multiple self-driving vehicles to be combined to form a virtual train.

According to an embodiment is a method that can include identifying, by a system comprising a memory and a processor, a first portion of a first traversal route grid associated with a first object and a second portion of a second traversal route grid associated with a second object. The identifying can be based on the first portion and the second portion being determined to be overlapping portions during a same time period. The method also can include linking, by the system, during the same time period, a first movement of the first object and a second movement of the second object across the overlapping portions.

In an example, the linking can include orientating the first object and the second object according to a configuration that facilitates energy conservation. The energy conservation can be a mitigation of a first amount of energy expended for the first movement of the first object.

In some implementations, the linking can include orienting the first object and the second object according to a configuration that facilitates a reduction in an amount of time for the first movement and the second movement across the overlapping portions.

According to some implementations, the linking can include determining, by the system, a first source location and a first destination location of the first object and a second source location and a second destination location of the second object. Further to these implementations, the linking can include determining, by the system, that the first object and the second object should be linked based on a match between a first route traveled by the first object from the first source location to the first destination location and a second route traveled by the second object from the second source location to the second destination location.

The first traversal route grid and the second traversal route grid can be represented as a three-dimensional space and a time element. In some implementations, the first object and the second object can be physical objects moving in a three-dimensional space. Further, the first object and the second object can be configured to operate according to a fifth generation communication protocol, a sixth generation communication protocol, or another advanced communication protocol.

According to some implementations, the first traversal route grid can represent first travel of the first object between a first source node and a first target node and can include first multiple alternative route segments between the first source node and the first target node. The second traversal route grid can represent second travel of the second object between a second source node and a second target node and can include second multiple alternative route segments between the second source node and the second target node.

In an example, the first object can be an autonomous vehicle and the method can include creating, by the system, the overlapping portions based on a modification to at least a portion of the first traversal route grid for the first object based on a type of the autonomous vehicle. Further to this example, the identifying can include selecting a first path based on the autonomous vehicle being determined to be an electric-powered vehicle. Alternatively, the identifying can include selecting a second path based on the autonomous vehicle being determined to be a gas-powered vehicle. Alternatively, the identifying can include selecting a third path based on the autonomous vehicle being determined to be a hybrid-powered vehicle.

Another embodiment provided herein relates to a system that can include a processor and a memory that stores executable instructions that, when executed by the processor, facilitate performance of operations. The operations can include determining a first route path between a first source location of a first movable object and a first destination location of the first movable object. The first route path includes a first group of alternative route paths. The operations also can include determining a second route path between a second source location of a second movable object and a second destination location of the second movable object. The second route path can include a second group of alternative route paths. Further, the operations can include selecting a first alternative route path of the first group of alternative route paths for the first movable object based on the first alternative route path coinciding, during a defined time interval, with a second alternative route path of the second group of alternative route paths for the second movable object.

In some implementations, the operations can include treating the first movable object and the second movable object as an object group during the defined time interval and while the first movable object and the second movable object are traversing the first alternative route path and the second alternative route path.

The operations can include, according to some implementations, reducing an amount of energy expended for a movement of the first movable object based on an orientation of the first movable object relative to the second movable object.

The first movable object and/or the second movable object can be classified as a type of device capable of horizontal movement and vertical movement. In some implementations, the first movable object and/or the second movable object can be configured to operate according to a fifth generation communication protocol. According to some implementations, the first movable object and/or the second movable object can be configured to operate according to a sixth generation communication protocol.

Another embodiment provided herein is a non-transitory machine-readable medium, comprising executable instructions that, when executed by a processor, facilitate performance of operations. The operations can include defining a first route for a first user equipment and a second route for a second user equipment, wherein a first starting position and a first ending position of the first user equipment is different from a second starting position and a second ending position of the second user equipment. The operations also can include identifying a first segment of the first route that overlaps with a second segment of the second route during a same time interval, resulting in an overlapping segment. Further, the operations can include facilitating movement of the first user equipment and the second user equipment to occur as a single unit during the overlapping segment.

According to some implementations, facilitating the movement can include reducing an amount of time taken by the first user equipment and the second user equipment to traverse the overlapping segment as compared to the first user equipment and the second user equipment moving independently over the overlapping segment.

The ability to autonomously link moving objects together by taking into consideration their longitude, latitude, altitude, time, distance from one another, or any other parameter along with destination point, arrival time, or any other parameter (e.g., slowing a particular assembly to allow another, higher priority assembly to pass) provides the ability to enhance the movement of objects in space by reducing roadway, airway, corridor, or other congestion, reducing energy consumption (e.g., by minimizing aerodynamic drag, avoiding intersection points, etc.), and simplifies autonomous movement algorithms for controlling how objects move in space, thus minimizing both response time and computing power necessary for system interwork.

These problems are addressed in the most rudimentary fashion in two-dimensional (2D) space (e.g., roadways). Such control includes limiting access to high-speed roadways via traffic signal; ubiquitous traffic control points (lights, stop signs), and other linear congestion management techniques that treat each individual entity with exactly the same priority (e.g., whoever gets to a control point first, wins). No system beyond toll-tags or window stickers allows and/or manages access to high-priority traffic lanes. To date, no such system exists for managing drone or other airway traffic beyond the Federal Aviation Administration (FAA) air traffic control system, which does not extend to low level three-dimensional (3D) space, does not control small remote aircraft (e.g., drones), and so on.

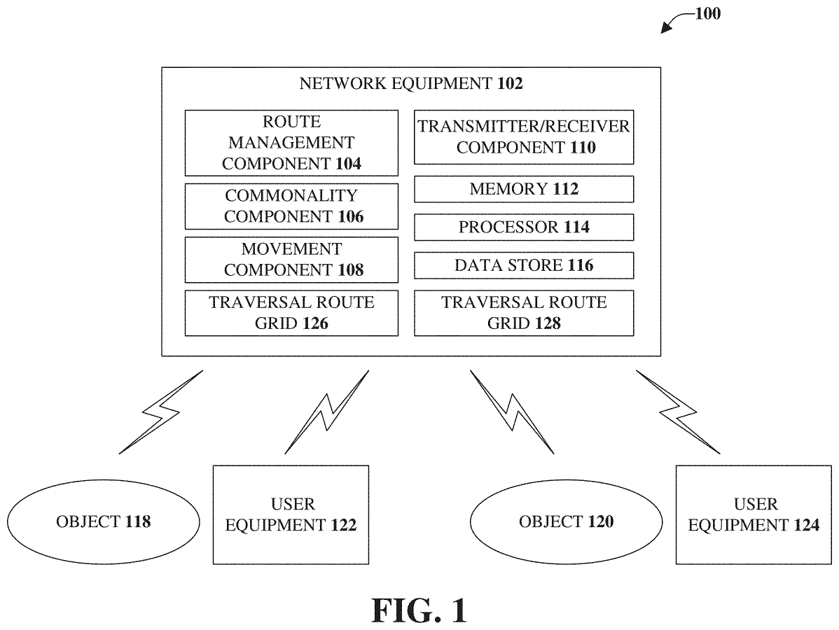

FIG. 1 illustrates an example, non-limiting, system 100 that facilitates autonomously linking the movement of objects in four dimensions in accordance with one or more embodiments described herein. The system can link items or objects that move together to form a virtual group (e.g., train, flock, and so on) to enhance flow of objects and reduce energy consumption utilize to move the objects.

The system 100 (as well as other systems discussed herein) can include a combination of controllers, data stores, authentication, billing, smart grids, control planes, and/or gateways. The system 100 can include network equipment 102, which can include a route management component 104, a commonality component 106, a movement component 108, a transmitter/receiver component 110, at least one memory 112, at least one processor 114, and at least one data store 116. The network equipment 102 can be in communication with one or more movement items or objects, illustrated as a first object 118 and a second object 120. The first object 118 and/or the second object 120 can be various moveable items such as, for example, an autonomous vehicle, a drone, a train, a ship, a package, a bag of food, a box of chocolate, a pizza, a person, and so on. The objects can be any physical object capable of movement in a three-dimensional space. Further, although various aspects are discussed with two objects, the disclosed aspects are not limited to this implementation and more than two objects can be moved as discussed herein. Additionally, the first object 118, the second object 120, and additional objects can be configured to operate according to a fifth generation communication protocol, a sixth generation communication protocol, or another advanced communication protocol.

The first object 118 can be capable of communication and can be associated with a first user equipment 122 and the second object 120 can be capable of communication and can be associated with a second user equipment 124. Further the first object 118 and the second object 120 can have respective specific attributes (e.g., capable of flight, can travel at a defined speed, amount of energy available, and so on). Although not illustrated, the first object 118, the second object 120, the first user equipment 122, and/or the second user equipment 124 can respectively include a transmitter/receiver component, one or more memories, one or more processors, and one or more data stores. In some implementations, the first object 118 and the first user equipment 122, the second object 120 and the second user equipment 124, can be separate, as illustrated. For example, if the first object 118 is a package (e.g., that contains pharmacy prescriptions), the first object 118 can be conveyed by a drone, which can be utilized as the first user equipment 122, and, thus, are capable of being separated. However, in some implementations, the first object 118 and the first user equipment 122 (and similarly the second object 120 and the second user equipment 124) can be co-located, such as in the case of an autonomous vehicle or the drone itself if the drone is being moved between locations.

Further, the communication between the network equipment 102, the first object 118, the second object 120, the first user equipment 122, and/or the second user equipment 124 can occur within a communications network and/or across multiple communications networks. For example, the disclosed aspects can be utilized locally within a city, across a state, among different states, different countries, and/or globally. Although a single network equipment, a single object, and a single user equipment are illustrated, according to various implementations, more than one network equipment, more than one object, and/or more than one user equipment can be included in the system 100.

Aspects of systems (e.g., the system 100 and the like), apparatuses, or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the network equipment 102, the first object 118, the second object 120, the first user equipment 122, and/or the second user equipment 124 can be any type of component, machine, device, facility, apparatus, and/or instrument that includes a processor and/or can be capable of effective and/or operative communication with a wired and/or wireless network. Components, machines, apparatuses, devices, facilities, and/or instrumentalities that can include the network equipment 102, the first object 118, the second object 120, the first user equipment 122, and/or the second user equipment 124 can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

The route management component 104 can identify a first traversal route grid 126 (e.g., a smart grid) for travel of the first object 118, a second traversal route grid 128 (e.g., a smart grid) for travel of the second object 120, and subsequent traversal route grids for subsequent objects. For example, an entity associated with the first object 118 and/or the first user equipment 122 can provide a request that includes an indication of a desired travel of the first object 118 from a first source location (also referred to as position, a source node, a first location, a start location, and so on) to a second position (also referred to as target location, a target node, a second location, an end location, and so on). In a similar manner, an entity associated with the second object 120 can include an indication of a desired travel of the second object 120 from a start location to an end location. As utilized herein an entity can be one or more computers, the Internet, one or more systems, one or more commercial enterprises, one or more computers, one or more computer programs, one or more machines, machinery, one or more users, one or more customers, one or more humans, and so forth, hereinafter referred to as an entity or entities depending on the context.

As discussed above, an explicit request can be provided, however, the disclosed aspects are not limited to this implementation and the determination of the traversal route grids can be based on an inference. For example, the inference can be based on respective historical information associated with the objects (e.g., where have the objects previously traveled, which can be determined based on a day of week (e.g., weekdays versus week ends) and/or a time (e.g., morning (when going to work) versus evening (when going to dinner)). In another example, the inference can be based on an established infrastructure, such as ingress and/or egress points (e.g., for autonomous vehicles on a highway, the next exit is in ten miles so the objects will be traveling together for at least ten miles). According to another example, the inference can be based on event venue information (e.g., a concert, an amusement park, or another area where a congregation of people and/or objects is expected or based on an ad hoc event (e.g., an emergency situation)).

For example, the route management component 104 can determine a first route path between a first source location of the first object 118 and a first destination location of the first object 118. The first route path can include a first group of alternative route paths. Further, the route management component 104 can determine a second route path between a second source location of the second object 120 and a second destination location of the second object 120. The second route path can include a second group of alternative route paths.

The commonality component 106 can determine respective portions of the first traversal route grid and the second traversal route grid that overlap during a same time period. The same time period can be determined based on comparing the first traversal route grid with the second traversal route grid and determining common portions based on the comparison.

Further, the commonality component 106 can select a first alternative route path of the first group of alternative route paths for the first object 118. To select the first alternative route, the commonality component 106 can determine that the first alternative route path coincides, during a defined time interval, with a second alternative route path of the second group of alternative route paths for the second object 120. The first alternative route path and the second alternative route path can be a same or similar route path (e.g., coinciding route paths, overlapping segments, a common route path, and so on).

The movement component 108 can facilitate first movement of the first object 118 along the first alternative route path and can facilitate second movement of the second object 120 along the second alternative route path during the defined time interval. To facilitate the first movement and the second movement, the movement component 108 can move the first object 118 and the second object 120 as a single object for the defined time interval and/or for the duration of the movement along the common route path.

To facilitate the first movement, the second movement, and/or movement of other objects, the movement component 108 can provide directions related to the respective route(s) that should be taken by the objects (e.g., the first object 118, the second object 120, another object, and so forth). In another example, the movement component 108 can provide respective visual electronic maps that can be utilized to move the objects. In yet another example, the movement component 108 can control the objects, at least partially, to cause the objects to move. Other manners of facilitating the movement of the objects can be provided by the movement component 108 as discussed herein.

The first object 118 and/or the second object 120 can leave the common route path as expected, or unexpectedly. For example, the first object and the second object are autonomous vehicles and occupants of a first vehicle (e.g., the first object) and occupants of a second vehicle (e.g., the second object) are planning to go to a sporting event. Thus, the first vehicle and the second vehicle are traveling, as a single unit, down a highway toward the sporting event. However, prior to arriving at the destination (e.g., the sporting event), the occupants of the second vehicle decide to change the travel destination, at least temporarily. For example, the occupants of the second vehicle could decide to stop at a diner, pick-up a friend, and so on. Accordingly, the second vehicle leaves the common route path and the route management component 104 (or another system component) can detect the movement of the second vehicle and can update a data store (e.g., the at least one data store 116) with information related to the change of course for the second vehicle.

A similar update to the data store can occur as other objects join in the common route path. Accordingly, the at least one data store 116 can be updated as new entrants and/or departures occur. For example, the objects can have unique identifiers that can be tracked by the movement component 108. The respective identifiers can be, but are not limited to, an Internet Protocol (IP) address, an International Mobile Equipment Identity (IMEI), or another physical and/or logical parameter enabled by the system 100.

According to some implementations, an object (e.g., the first object, the second object and so on) can be an autonomous vehicle and the route management component 104 can choose a path from a group of paths based on a type of the autonomous vehicle. For example, if the autonomous vehicle is an electric-powered vehicle, a first path can be selected. The first path can provide better opportunities for recharging the electric-powered vehicle as compared to other paths. If the autonomous vehicle is a gas-powered vehicle, a second path can be selected. The second path can provide better opportunities for fueling the gas-powered vehicle as compared to other paths. Further, if the autonomous vehicle is a hybrid vehicle, a third path can be selected. The third path can provide better opportunities for charging and/or fueling the hybrid vehicle as compared to other paths. The first, second, and third path can be different paths. In some implementations, at least two of the first, second, and third path can be the same path.

The transmitter/receiver component 110 can receive, from the first object 118 and/or the first user equipment 122 a first request to move the first object 118 from a first location, which can be a current location, to one or more other locations, a requested time of arrival at each of the one or more other locations, acceptance of the respective values, denial of the respective values, and/or other information. Additionally, or alternatively, transmitter/receiver component 110 can receive, from the second object 120 and/or the second user equipment 124 a second request to move the second object 120 from a second location, which can be a current location of the second object 120, to one or more other locations, a requested time of arrival at each of the one or more other locations, acceptance of the respective values, denial of the respective values, and/or other information.

Further, the transmitter/receiver component 110 can send to the first object 118, the first user equipment 122, the second object 120, the second user equipment 124, and so on, the first information, the second information, and/or other information.

The at least one memory 112 can be operatively connected to the at least one processor 114. The at least one memory 112 can store executable instructions that, when executed by the at least one processor 114 can facilitate performance of operations. Further, the at least one processor 114 can be utilized to execute computer executable components stored in the at least one memory 112.

For example, the at least one memory 112 can store protocols associated with facilitating movement of multiple objects as a single unit during at least a portion of travel of the multiple objects. Further, the at least one memory 112 can facilitate action to control communication between the first object 118, the second object 120, the first user equipment 122, and/or the second user equipment 124, the network equipment 102, one or more other network equipment, one or more other objects, one or more other user equipment, and so on, such that the network equipment 102 can employ stored protocols and/or algorithms to facilitate providing a multitude of virtual paths for moving multiple objects as a single unit during respective portions of the multiple virtual paths in advanced networks as described herein.

It should be appreciated that data stores (e.g., memories) components described herein can be either volatile memory or nonvolatile memory, or can include both volatile and nonvolatile memory. By way of example and not limitation, nonvolatile memory can include Read Only Memory (ROM), Programmable ROM (PROM), Electrically Programmable ROM (EPROM), Electrically Erasable ROM (EEPROM), or flash memory. Volatile memory can include Random Access Memory (RAM), which acts as external cache memory. By way of example and not limitation, RAM is available in many forms such as Static RAM (SRAM), Dynamic RAM (DRAM), Synchronous DRAM (SDRAM), Double Data Rate SDRAM (DDR SDRAM), Enhanced SDRAM (ESDRAM), Synchronous Link DRAM (SLDRAM), and Direct Rambus RAM (DRRAM). Memory of the disclosed aspects are intended to include, without being limited to, these and other suitable types of memory.

The at least one processor 114 can facilitate respective analysis of information related to virtual paths and autonomously linking objects in advanced networks. The at least one processor 114 can be a processor dedicated to analyzing and/or generating information received, a processor that controls one or more components of the network equipment 102, and/or a processor that both analyzes and generates information received and controls one or more components of the network equipment 102.

Further, the term network equipment is used herein to refer to any type of network node serving a User Equipment (UE) and/or connected to other network equipment, network nodes, network elements, or another network node from which the UEs can receive a radio signal. In cellular radio access networks (e.g., Universal Mobile Telecommunications System (UMTS) networks), network nodes can be referred to as Base Transceiver Stations (BTS), radio base station, radio network nodes, base stations, NodeB, eNodeB (e.g., evolved NodeB), and so on. In 5G terminology, the network nodes can be referred to as gNodeB (e.g., gNB) devices. Network nodes can also include multiple antennas for performing various transmission operations (e.g., Multiple-Input Multiple-Output (MIMO) operations). A network node can include a cabinet and other protected enclosures, an antenna mast, and actual antennas. Network nodes can serve several cells, also called sectors, depending on the configuration and type of antenna. Examples of network nodes can include but are not limited to: NodeB devices, Base Station (BS) devices, Access Point (AP) devices, and Radio Access Network (RAN) devices. The network nodes can also include Multi-Standard Radio (MSR) radio node devices, comprising: an MSR BS, an eNode B, a network controller, a Radio Network Controller (RNC), a Base Station Controller (BSC), a relay, a donor node controlling relay, a Base Transceiver Station (BTS), a transmission point, a transmission node, a Remote Radio Unit (RRU), a Remote Radio Head (RRH), nodes in Distributed Antenna System (DAS), and the like.

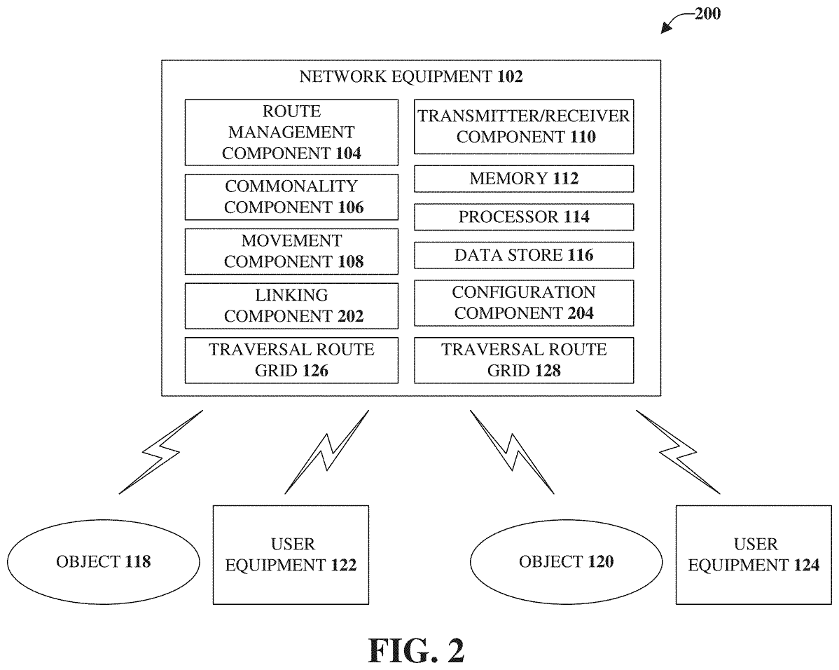

FIG. 2 illustrates an example, non-limiting, system 200 that facilitates moving two or more objects as a single unit based on the two or more objects traversing a route segment at a same time in accordance with one or more embodiments described herein. Repetitive description of like elements employed in other embodiments described herein is omitted for sake of brevity. The system 200 can include one or more of the components and/or functionality of the system 100, and vice versa.

The network equipment 102 can include a linking component 202 that can treat the first object 118 and the second object 120 as an object group (e.g., a single unit) during a defined time interval. The objects can be classified as a type of device capable of horizontal movement and/or vertical movement. For example, the object can be a drone, an aircraft, a shipping vessel, a jet pack, a rocket belt, a rocket pack, and so on. The defined time interval can be the period of time during which the first object 118 and the second object 120 are traversing their respective paths at a common segment. Accordingly, the defined time interval is not a “set” time but is a time that can be established based on detection of the overlapping portions. For example, the time period does not need to be established a priori but can be established upon or after it is determined that two or more objects have segments (or portions) or a route that overlap or that can be caused to overlap at about the same time.

The linking or treating of the two or more objects as a single unit is not a physical linking of the objects. Instead, the objects are linked in a “virtual” or non-physical manner for purposes of movement of the objects. By way of analogy, a city can have a public transportation system, such as a transit, subway, train, and so on. However, smaller cities might not have a public transportation system, or might simply employ buses or similar vehicles. Further, the public transportation system that is available might not connect to one or more popular locations or might not extend far enough into suburban areas to be beneficial to a large number of users. The limitations of such public transportation systems might be due to the cost associated with the infrastructure as well as the return on investment. Accordingly, the disclosed aspects provide for the linking of one or more objects that are traveling in a same direction such that the objects become a virtual rail system or virtual train. Further, the linked objects are not tied to a physical path according to some implementations. However, in some implementations, the linked objects can be tied to a physical path, or at least one object can be tied to a physical path. Further, the traversal route paths could be multi-dimensional such as a horizontal movement (X axis), a vertical movement (Y axis), a horizontal and vertical movement (Z axis), and can have a time element.

Further, the objects can be linked together automatically and in real-time. For example, two or more objects can be linked based on a determination that the objects are traveling in a same direction and are within a defined distance of one another, even though the travel was not predetermined.

Further, the network equipment 102 can include a configuration component 204 that can facilitate an orientation of the two or more objects in order to reduce or mitigate an amount of energy expended for movement of the objects (e.g., energy conservation). According to some implementations, the configuration component 204 can facilitate an orientation of the two or more objects in order to mitigate or reduce an amount of time for movement of at least one of the objects across the overlapping portions.

For example, by treating the objects as a single unit, rather than individual objects, the objects can be oriented with respect to one another in order to improve efficiencies related to movement of the objects. For example, an efficiency can be the amount of energy consumed by the objects for the movement. The objects can be oriented in such a manner that one or more forces that resist motion or the aerodynamic effects of air flow over the objects (drag) is mitigated or reduced. Thus, if drag can be reduced, the amount of energy consumed for movement of the objects can be conserved. Another efficiency can be the amount of time required for the objects to travel the overlapping distance. Thus, if drag is reduced, it is possible that the objects can travel faster.

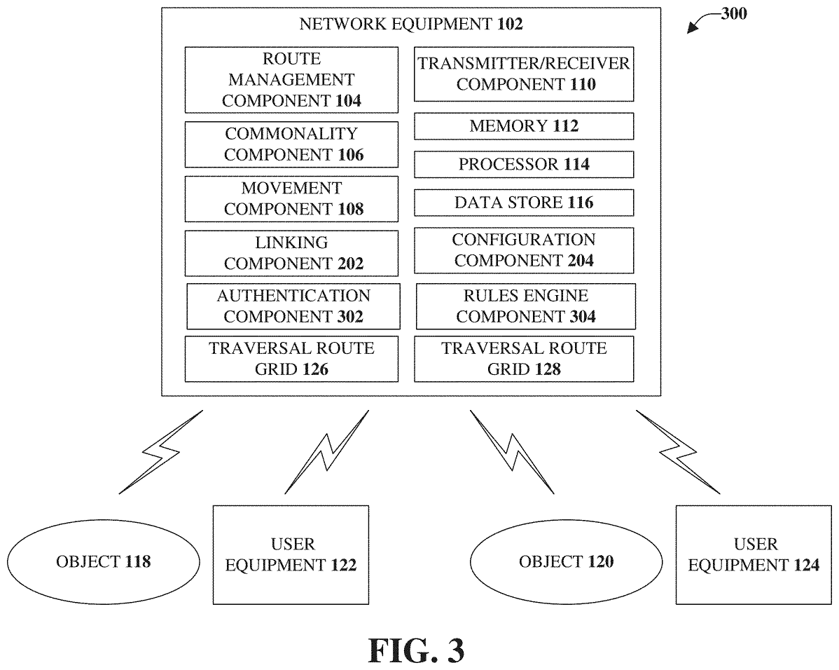

FIG. 3 illustrates an example, non-limiting, system 300 that facilitates assigning values to a multitude of virtual paths for moving multiple objects as a single unit in accordance with one or more embodiments described herein. Repetitive description of like elements employed in other embodiments described herein is omitted for sake of brevity. The system 300 can include one or more of the components and/or functionality of the system 100, the system 200, and vice versa.

The system 300 (as well as other embodiments discussed herein) provides a mechanism for spontaneous, directed self-assembly, generating assemblies of any desired geometry (e.g., not limited to linear virtual trains, but also to stars, amorphous clusters, aerodynamic clusters (drones), and more as desired). Further, the various embodiments discussed herein permit directed or spontaneous disassembly and/or assembly enroute, reassembly enroute as cohort members are added (e.g., such a member would be added only when that member is additive to energy savings), and optimization of assembly characteristics across all dimensions as movement proceeds. Each assembly can thus be prioritized automatically by the system against any parameter for speedy transit.

The route management component 104 can define a first route for the first object 118 (and/or the first user equipment 122) and a second route for the second object 120 (and/or the second user equipment 124). For example, the first route for the first object 118 can be from a first starting position to a first ending position and the second route for the second object 120 can be from a second starting position to a second ending position. The first starting position and the second starting position can be a same position or different positions. Further, the first ending position and the second ending position can be a same position or different positions.

The request of the desired travel can include, but is not limited to, a from location, a to location, and an arrival time. According to some implementations, the request can include one or more manageable parameters. For example, a manageable parameter can be a fuel consumption, another manageable parameter can be brake wear and/or avoidance of other wear conditions.

The commonality component 106 can identify a first segment of the first route that overlaps with a second segment of the second route during a same time interval. The identified segments (e.g., the first segment and the second segment) can be overlapping segments.

Further, the linking component 202 can link, during the same time interval, a first movement of the first object 118 and a second movement of the second object 120. The first movement and the second movement can be facilitated by the movement component 108. The linkage can cause the system 300 to consider or treat the first object 118 and the second object 120 as a single object or item.

According to some implementations, an authentication component 302 can authenticate use of the system 200 by the first object 118 and/or the first user equipment 122. For example, the authentication component 302 can interact with the at least one data store 116, which can be an authentication and registration data store according to some implementations. Further, the authentication component 302 can register the first object 118 and/or the first user equipment 122 for use of the system 200. The authentication component 302 can also authenticate use of the system 300 by the second object 120 and/or the second user equipment 124, as well as subsequent objects and/or subsequent user equipment. Further, according to some implementations, the authentication and registration data store can be included, at least partially, on the first object 118, the first user equipment 122, the second object 120, the second user equipment 124, subsequent objects, and/or subsequent user equipment.

A rules engine component 304 can join one or more objects together as a single unit based on various considerations. Such considerations can include a type of the object (e.g., electric powered vehicles grouped together, gas-powered vehicles grouped together, and so on). However, the objects do not need to be group by type of objects. In another example, the rules engine component 304 can join the one or more object based on preferences of the objects, preferences of an entity associated with (or that owns or controls) the route being traversed, and so on. For example, the route (or at least a segment thereof) can be a private road controlled by defined conditions (e.g., do not use the property in the rain). In another example, the rule can be to avoid a particular area during a flash flood or based on potential flood conditions. Further, another rule can be associated with billing and/or payments associated with a route segment.

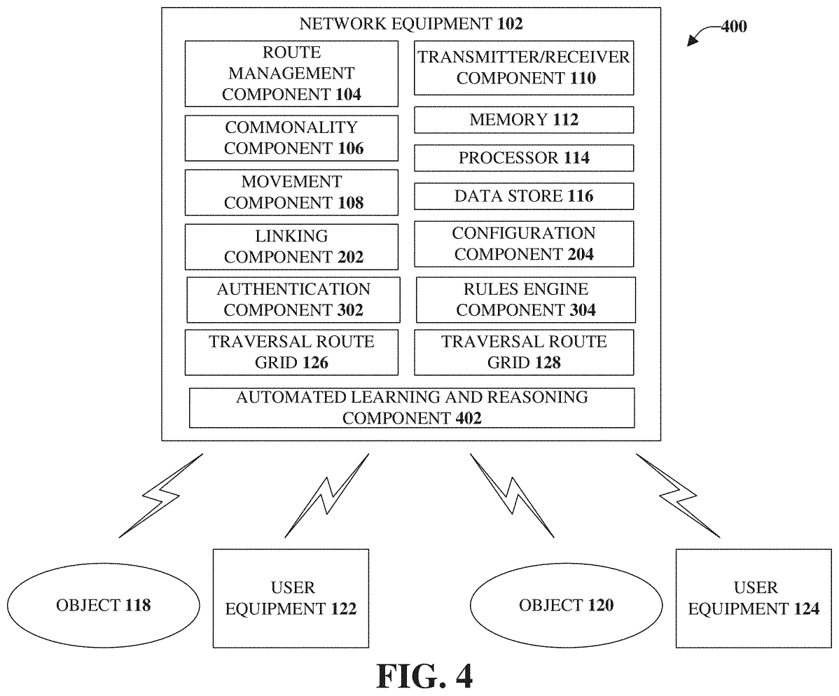

FIG. 4 illustrates an example, non-limiting, system 400 that employs automated learning to facilitate one or more of the disclosed aspects in accordance with one or more embodiments described herein. Repetitive description of like elements employed in other embodiments described herein is omitted for sake of brevity. The system 400 can include one or more of the components and/or functionality of the system 100, the system 200, the system 300, and vice versa.

As illustrated, the network equipment 102 can include an automated learning and reasoning component 402 that can be utilized to automate one or more of the disclosed aspects. The automated learning and reasoning component 402 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the automated learning and reasoning component 402 can employ principles of probabilistic and decision theoretic inference. Additionally, or alternatively, the automated learning and reasoning component 402 can rely on predictive models constructed using automated learning and/or automated learning procedures. Logic-centric inference can also be employed separately or in conjunction with probabilistic methods.

The automated learning and reasoning component 402 can determine whether two objects are expected to travel together for a defined period and are travelling within a defined geographic range of one another. The defined geographic range can be determined based on efficiencies that can be created by linking the objects. Based on this knowledge, the automated learning and reasoning component 402 can automatically link the objects in order to realize the efficiencies.

As used herein, the term “inference” refers generally to the process of reasoning about or inferring states of a system, a component, a module, an environment, and/or devices from a set of observations as captured through events, reports, data and/or through other forms of communication. Inference can be employed to identify one or more paths, one or more values, or can generate a probability distribution over states, for example. The inference can be probabilistic. For example, computation of a probability distribution over states of interest based on a consideration of data and/or events. The inference can also refer to techniques employed for composing higher-level events from a set of events and/or data. Such inference can result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

The various aspects (e.g., in connection with determining whether one or more objects should be linked, efficiencies realized by linking the one or more objects, facilitating the linkage of the one or more objects, and so forth) can employ various artificial intelligence-based schemes for carrying out various aspects thereof. For example, a process for determining if two or more objects share a common source location, a common target location, or a location between the source location and the target location can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to provide a prognosis and/or infer one or more actions that should be employed to determine how to move and link objects within a smart grid. In the case of routes, for example, attributes can be identification of common routes, rules associated with the linkage of the objects, restrictions or preferences associated with the route and the classes are criteria of respective destinations of the objects, respective requested times of arrival, respective parameters associated with the objects, and so forth that should be considered to facilitate the linkage of objects as discussed herein.

A Support Vector Machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing object travel patterns, the amount of objects moving along routes and/or linkage of various objects within the routes, and so on). For example, SVMs can be configured through a learning or training phase within a classifier constructor and feature selection module. Thus, a classifier(s) can be used to automatically learn and perform a number of functions, including but not limited to determining, according to a predetermined criterion, when to link one or more objects, when to add an object to the linkage, when to remove an object from the linkage, and so forth. The criteria can include, but is not limited to, similar start locations, similar end locations, and so forth.

Additionally, or alternatively, an implementation scheme (e.g., a rule, a policy, and so on) can be applied to control and/or regulate the linkage of objects. In some implementations, based upon a predefined criterion, the rules-based implementation can automatically and/or dynamically implement movement of one or more objects as a single unit. In response thereto, the rule-based implementation can automatically interpret and carry out functions associated with the objects by employing a predefined and/or programmed rule(s) based upon any desired criteria. For example, the automated learning and reasoning component 402 can slow down and/or speed up traffic (e.g., movement of the linked objects) based on one or more controller inputs, including providing intelligent priority to first responders. Further, the automated learning and reasoning component 402 can adjust the routes, or portions thereof based on a type of entity, a type of object, an owner of the route, and so on. In addition, the automated learning and reasoning component 402 can determine whether it is acceptable to change at least a portion of a route for an object to enable linkage of that object with other objects, at least for a period of time.

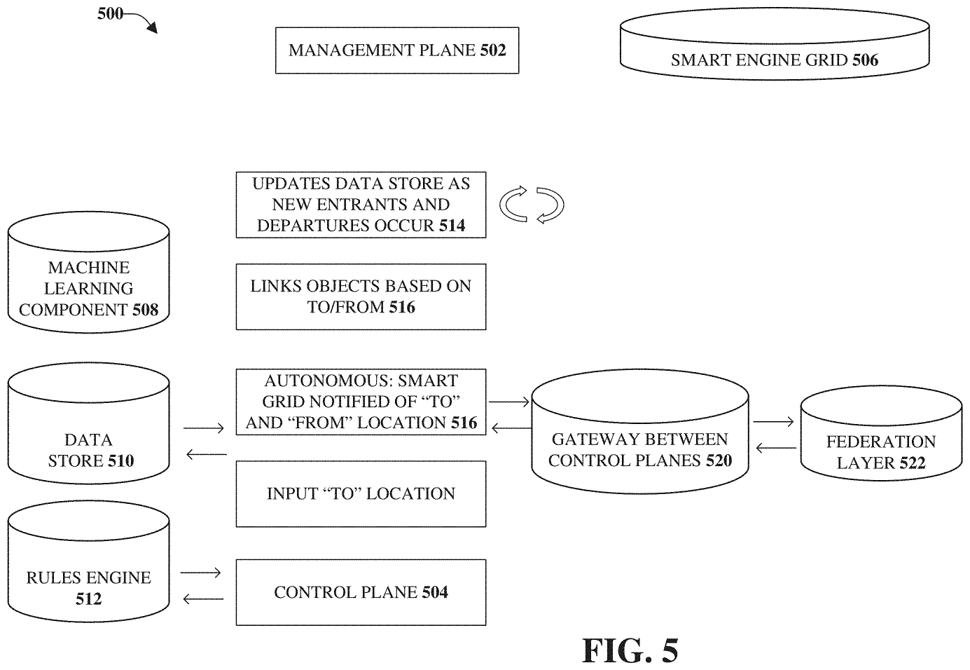

FIG. 5 illustrates an example, non-limiting, system 500 that facilitates linking of objects in accordance with one or more embodiments described herein. Repetitive description of like elements employed in other embodiments described herein is omitted for sake of brevity. The system 500 can include one or more of the components and/or functionality of the system 100, the system 200, the system 300, the system 400, and vice versa.

The system 500 can include a management plane 502 and a control plane 504. The management plane 502 can include, or can be utilized for, a smart engine grid 506 (e.g., the, the first traversal route grid 126, the second traversal route grid 128, and so on).

Illustrated in the control plane 504 are a machine learning component 508 (e.g., the automated learning and reasoning component 402), a data store 510 (e.g., the at least one data store 116), and a rules engine 512 (e.g., route management component 104, the rules engine component 304). As indicated at 514, the machine learning component 508 can update the data store 510 as new entrants (e.g., new objects) are linked or associated with a common route path. Further, the machine learning component 508 can update the data store 510 as departures occur (e.g., as objects leave the common route path and should no longer be linked with other objects on the common route path). It is noted that the update to the data store 510 can be continually performed by the machine learning component 508 as objects enter and/or leave various segments of the traversal route grid.

At 516, the machine learning component 508 can link objects based on a source location, a target location, or a segment of a route between the source location and the target location. Further, the smart engine grid 506 can be automatically notified of the “to” and “from” locations (e.g., can be performed autonomously by the system 500), as indicated at 516. The notification can occur by sending to and/or receiving from a gateway between control planes 520 information indicative of the “to” and/or “from” locations. The notification can also be sent to and/or received from a federation layer 522.

In further detail, the system 500 (as well as other systems and/or embodiments discussed herein) allows for the linkage of moving objects to move autonomously as a virtual group through space. The dimensions the system tracks via, for example, the data store 510 and a “smart grid” (e.g., the smart engine grid 506) are longitude, latitude, altitude, and time. Overlaying the knowledge of where an object is moving “to” (e.g., an end destination) and where the object resides at any time period (e.g., its current location), allows the control plane 504 to communicate to the smart grid to link objects together to form a virtual singular moving object.

Linkage can take place by many objects meeting at a common meet point for linkage, or by a moving object intersecting with another moving object. Further, the linkage can be broken by releasing a given object already a member of the assembly (e.g., based on the object leaving the group).

The control plane 504 can determine, based on the data store 510, the “to” and “from” location, and where any object is at any time. The data store 510 can receive this information via the smart grid and the machine learning component 508. The machine learning component 508 can learn tendencies for objects, which can provide predictive capability to share with the smart grid. Tendencies for objects can be determined through historical data as presented to the data store (e.g., 31% of the time this vehicle stops at position X on weekdays between 5:00 p.m. and 5:30 p.m. local time). Thus, the machine learning component 508 can perform predictions against such events and present those to the smart grid, which can then adjust itself and the expectations for objects. This adjustment can allow for pre-calculation of necessary smart grid actions to be taken and thus instantiations of those actions in near real time versus after a long interval for calculations. In short, system “surprises,” can be minimized by the nature of the system.

The data store 510 can be updated as objects enter, exit, or request access to the system. When request for access is made via the smart grid, the data store 510 can provide feedback to expected linkage location to the smart grid, and continual feedback can occur until linkage is completed.

The machine learning component 508 can be used to increase the likelihood of matching the linkage point correctly. A gateway (e.g., the gateway between control planes 520) can be used to link control planes, since control planes do not have unlimited scope, the gateway can be used to establish the federation layer 522 to allow multiple control planes access to the system 500. This allows intra-geographic regions to link to inter-regions. This also can provide handoffs between intra-geography regions. Further, the machine learning component 508 (and associated machine learning algorithms) provides self-learning capability to the system 500. Transaction processing is used in data gathering to perform subsequent analysis. Once objects are linked, the smart grid receives an identifier from the control plane 504 to manage this as one singular object. Dimensions are provided via a data store 602 to the control plane 504 to the smart grid. The control plane 504 continues to update the smart grid as exit and/or entry of objects occur.

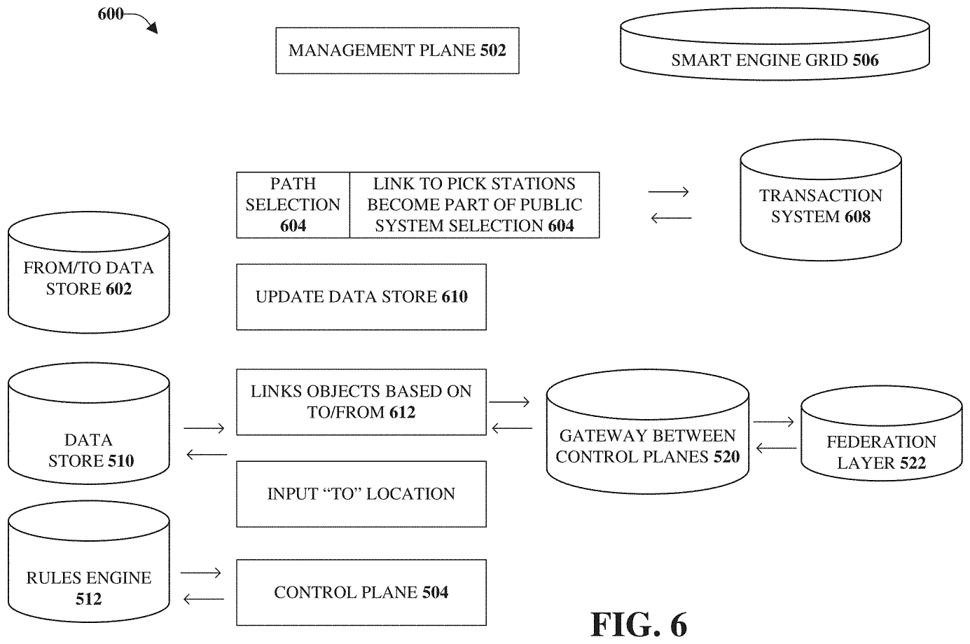

FIG. 6 illustrates an example, non-limiting, system 600 that facilitates moving multiple objects as a single unit in accordance with one or more embodiments described herein. Repetitive description of like elements employed in other embodiments described herein is omitted for sake of brevity. The system 600 can include one or more of the components and/or functionality of the system 100, the system 200, the system 300, the system 400, the system 500, and vice versa.

The system 600 includes a data store 602 that can retain “to” and/or “from” information related to one or more objects. Based on the data retained in the data store 602 a path selection 604 can be made (e.g., via the route management component 104). According to some implementations, there can be a link to pick stations, which can become part of the public system, as indicated at 606. To facilitate such linkage, access to a transaction system 608 can be enabled. According to some implementations, linkage with the transaction system 608 or public system can facilitate path control. At 610, the data store 510 can be updated with the path selection information. The objects can be linked, at 612, based, at least in part on the “to” and/or “from” information.

Methods that can be implemented in accordance with the disclosed subject matter will be better appreciated with reference to various flow charts. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

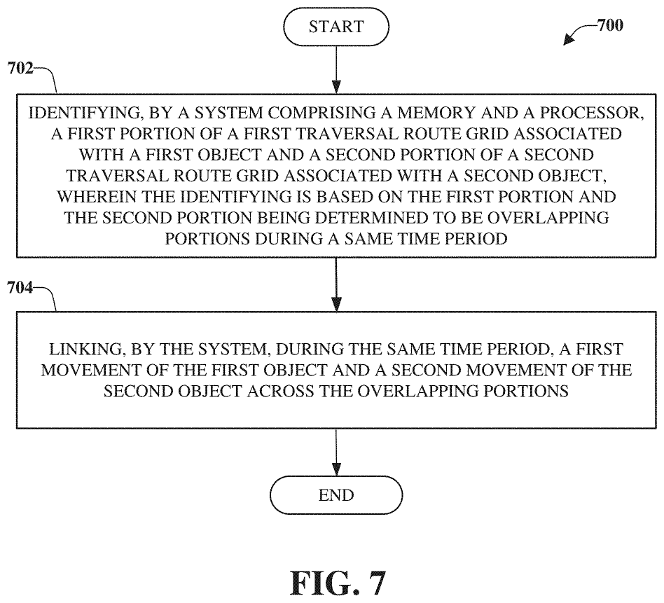

FIG. 7 illustrates a flow diagram of an example, non-limiting, computer-implemented method 700 for facilitating autonomous linking of movement of one or more objects in advanced networks in accordance with one or more embodiments described herein. Repetitive description of like elements employed in other embodiments described herein is omitted for sake of brevity.

In some implementations, a system comprising a processor can perform the computer-implemented method 700 and/or other methods discussed herein. In other implementations, a device comprising a processor can perform the computer-implemented method 700 and/or other methods discussed herein. In other implementations, a machine-readable medium, can include executable instructions that, when executed by a processor, facilitate performance of operations, which can be the operations discussed with respect to the computer-implemented method 700 and/or other methods discussed herein. In further implementations, a machine readable or computer readable storage device comprising executable instructions that, in response to execution, cause a system comprising a processor to perform operations, which can be operations discussed with respect to the computer-implemented method 700 and/or other methods discussed herein. Further, in some implementations, various equipment comprising at least one processor can perform the computer-implemented method 700 and/or other methods discussed herein.

The computer-implemented method 700 starts at 702, with identifying, by a system comprising a memory and a processor, a first portion of a first traversal route grid associated with a first object and a second portion of a second traversal route grid associated with a second object (e.g., via the route management component 104). The identifying can be based on the first portion and the second portion being determined to be overlapping portions during a same time period. The first traversal route grid and the second traversal route grid can be represented as a three-dimensional space and a time element.

The first traversal route grid can represent first travel of the first object between a first source node and a first target node and can include first multiple alternative route segments between the first source node and the first target node. The second traversal route grid can represent second travel of the second object between a second source node and a second target node and can include second multiple alternative route segments between the second source node and the second target node.

The first traversal route grid and the second traversal route grid can be determined based on an explicit indication of a start location and a destination location, an inferred indication based on respective historical information associated with the objects, an inferred indication based on egress points (e.g., for autonomous vehicles on a highway, the next exit is in six miles so the objects should be traveling together for at least six miles).

Further, at 704 the system can link, during the same time period, a first movement of the first object and a second movement of the second object across the overlapping portions (e.g., via the linking component 202). The time period can be established based on detection of the overlapping portions. For example, the time period does not need to be established a priori but can be identified when it is determined that two or more objects have segments (or portions) or a route that overlap or that can be caused to overlap at about the same time.

The linking or treating of the two or more objects as a single unit is not a physical linking of the objects. Instead, the objects are linked in a “virtual” or non-physical manner. For example, by treating the objects as a single unit, rather than individual objects, the objects can be oriented with respect to one another in order to improve efficiencies (e.g., energy consumption, required time of travel, congestion, and so on) associated with the two or more objects linked together. For example, the linkage of the objects can include orientating the objects with respect to one another to facilitate energy conservation. The energy conservation can be a mitigation of a first amount of energy expended for the first movement of the first object, a second amount of energy expended for second movement of the second object, and/or other amounts of energy expended for other movements of other objects that are linked together. According to some implementations, the linking can include orienting the first object and the second object according to a configuration that facilitates a reduction in an amount of time for the first movement and the second movement (as well as other movement of other linked objects) across the overlapping portions.

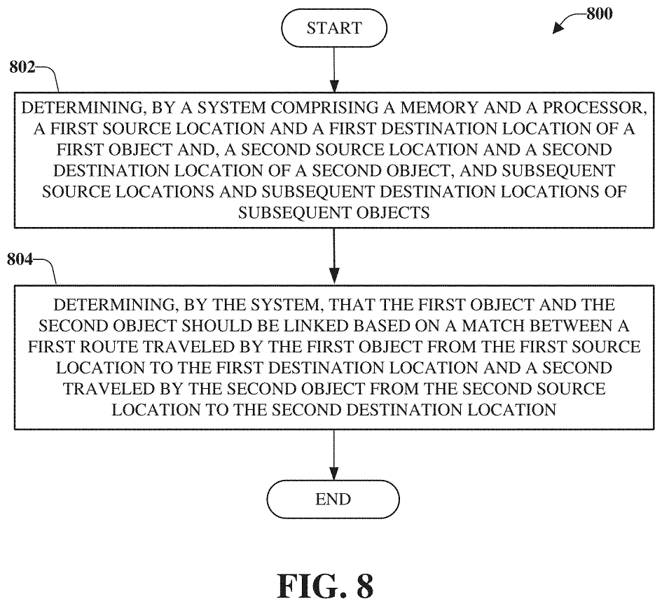

FIG. 8 illustrates a flow diagram of an example, non-limiting, computer-implemented method 800 for determining two or more objects should be linked such that the two or more objects are treated as a single unit during movement of the two or more objects in accordance with one or more embodiments described herein. Repetitive description of like elements employed in other embodiments described herein is omitted for sake of brevity.

The computer-implemented method 800 starts, at 802, with determining, by a system comprising a memory and a processor, a first source location and a first destination location of a first object, a second source location and a second destination location of a second object, and subsequent source locations and subsequent destination locations of subsequent objects (e.g., via the route management component 104). The determination can be based on explicit information received and/or an inference based on historical information, established infrastructure, event venue information, and so on.

At 804, the system can determine that the first object and the second object should be linked based on a match between a first route traveled by the first object from the first source location to the first destination location and a second route traveled by the second object from the second source location to the second destination location (e.g., via the commonality component 106). For example, the respective traversal route grids can include alternative route segments that can be traversed by the objects. Accordingly, it can be determined that, by selecting a first alternative route segment instead of a second alternative route segment, the objects can be linked to obtain the benefits as discussed herein.

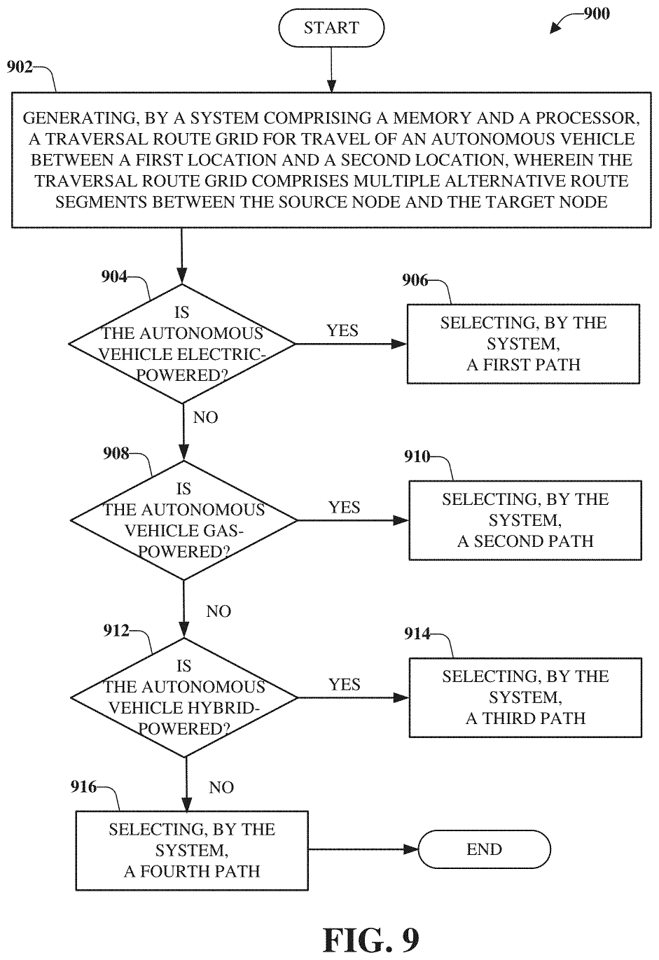

FIG. 9 illustrates a flow diagram of an example, non-limiting, computer-implemented method 900 for selecting between alternative routes in accordance with one or more embodiments described herein. Repetitive description of like elements employed in other embodiments described herein is omitted for sake of brevity.

The computer-implemented method starts, at 902, when a traversal route grid for travel of an autonomous vehicle from a first location to at least a second location is generated (e.g., via the route management component 104). The traversal route grid can include multiple alternative route segments between the first location and the second location. Generating the traversal route grid can include choosing a path from a group of paths based on a type of autonomous vehicle.

Accordingly, determinations can be made related to the type of object being considered. Thus, at 904, a first determination can be made whether the autonomous vehicle is an electric-powered vehicle. If yes, at 906, a first path can be selected. The first path can be a path that provides opportunities to recharge one or more batteries of the autonomous vehicle. For example, the opportunities can include one or more charging stations along the route. In another example, the opportunities can include more braking action in order to cause charging of the one or more batteries of the autonomous vehicle (e.g., more stops, more traffic lights, more turns, and so on).

If the determination at 904 is that the autonomous vehicle is an electric-powered vehicle (“NO”), at 908 a determination can be made whether the autonomous vehicle is a gas-powered vehicle. If the vehicle is gas-powered (“YES”), at 910, a second path can be chosen. The second path can be a path that has more gas stations and/or service station locations than other paths. According to some implementations, the first path and the second path can be the same path.

Further, if the determination at 908 is that the vehicle is not a gas powered vehicle, a third determination can be made, at 912, whether the autonomous vehicle is a hybrid-powered vehicle. If so (“YES”), at 914, a third path can be selected for the autonomous vehicle. According to some implementations, the third path can be the same as the first path or the same as the second path. However, in some implementations, the third path can be a different path than the first path and the second path.

If the third determination is that the autonomous vehicle is not a gas powered vehicle or the type of vehicle is not known (“NO”), a fourth path can be selected at 916. The fourth path can be different from the first path, the second path, and the third path. In some cases, the fourth path can be the same as one of the first path, the second path, and the third path.

In accordance with some implementations, the selection of the first path at 906, the second path at 910, and/or the third path 914 can be contingent upon acceptance of the path. Accordingly, if the respective path is not acceptable, another path can be chosen, which can be based on preferences, rules, policies, historical information associated with the object and/or entity, and so on. Further, any of the paths can consider such parameters in addition to the consideration as to the type of autonomous vehicle. The autonomous vehicle can be moved along the selected route (or an alternative route thereof) as discussed herein.

As discussed herein, individual objects that are linked together can be treated in singularity versus multiple objects moving together. Further, the linkage of the objects takes into consideration four dimensions (altitude, longitude, latitude, and time) and combines this with destination, current location, object tendency, object history, a minimization algorithm (be it energy, time, stops at signals (virtual or real), or any other adjustable parameter).

Described herein are systems, methods, articles of manufacture, and other embodiments or implementations that can facilitate autonomous linking the movement of objects in four dimensions in advanced networks in advanced networks. Facilitating autonomous linking the movement of objects in four dimensions in advanced networks can be implemented in connection with any type of device with a connection to the communications network (e.g., a mobile handset, a computer, a handheld device, etc.) any Internet of things (IoT) device (e.g., toaster, coffee maker, blinds, music players, speakers, water meter, etc.), and/or any connected vehicles (e.g., cars, airplanes, boats, space rockets, and/or other at least partially automated vehicles (e.g., drones), and so on). In some embodiments, the non-limiting term User Equipment (UE) is used. It can refer to any type of wireless device that communicates with a radio network node in a cellular or mobile communication system. Examples of UE are target device, device to device (D2D) UE, machine type UE or UE capable of machine to machine (M2M) communication, PDA, Tablet, mobile terminals, smart phone, Laptop Embedded Equipped (LEE), laptop mounted equipment (LME), USB dongles etc. Note that the terms element, elements, and antenna ports can be interchangeably used but carry the same meaning in this disclosure. The embodiments are applicable to single carrier as well as to Multi-Carrier (MC) or Carrier Aggregation (CA) operation of the UE. The term Carrier Aggregation (CA) is also called (e.g., interchangeably called) “multi-carrier system,” “multi-cell operation,” “multi-carrier operation,” “multi-carrier” transmission and/or reception.

In some embodiments, the non-limiting term radio network node or simply network node is used. It can refer to any type of network node that serves one or more UEs and/or that is coupled to other network nodes or network elements or any radio node from where the one or more UEs receive a signal. Examples of radio network nodes are Node B, Base Station (BS), Multi-Standard Radio (MSR) node such as MSR BS, eNode B, network controller, Radio Network Controller (RNC), Base Station Controller (BSC), relay, donor node controlling relay, Base Transceiver Station (BTS), Access Point (AP), transmission points, transmission nodes, RRU, RRH, nodes in Distributed Antenna System (DAS) etc.

To meet the huge demand for data centric applications, 4G standards can be applied to 5G, also called New Radio (NR) access. The 5G networks can include the following: data rates of several tens of megabits per second supported for tens of thousands of users; 1 gigabit per second can be offered simultaneously (or concurrently) to tens of workers on the same office floor; several hundreds of thousands of simultaneous (or concurrent) connections can be supported for massive sensor deployments; spectral efficiency can be enhanced compared to 4G; improved coverage; enhanced signaling efficiency; and reduced latency compared to Long Term Evolution (LTE).

Multiple Input, Multiple Output (MIMO) systems can significantly increase the data carrying capacity of wireless systems. For these reasons, MIMO is an integral part of the third and fourth generation wireless systems (e.g., 3G and 4G). In addition, 5G systems also employ MIMO systems, which are referred to as massive MIMO systems (e.g., hundreds of antennas at the transmitter side (e.g., network) and/receiver side (e.g., user equipment). With a (Nₜ,Nᵣ) system, where Nₜ denotes the number of transmit antennas and Nr denotes the receive antennas, the peak data rate multiplies with a factor of Nₜ over single antenna systems in rich scattering environment.

In addition, advanced networks, such as a 5G network can be configured to provide more bandwidth than the bandwidth available in other networks (e.g., 4G network, 5G network). A 5G network can be configured to provide more ubiquitous connectivity. In addition, more potential of applications and services, such as connected infrastructure, wearable computers, autonomous driving, seamless virtual and augmented reality, “ultra-high-fidelity” virtual reality, and so on, can be provided with 5G networks. Such applications and/or services can consume a large amount of bandwidth. For example, some applications and/or services can consume about fifty times the bandwidth of a high-definition video stream, Internet of Everything (IoE), and others. Further, various applications can have different network performance requirements (e.g., latency requirements and so on).

Cloud Radio Access Networks (cRAN) can enable the implementation of concepts such as SDN and Network Function Virtualization (NFV) in 5G networks. This disclosure can facilitate a generic channel state information framework design for a 5G network. Certain embodiments of this disclosure can include an SDN controller that can control routing of traffic within the network and between the network and traffic destinations. The SDN controller can be merged with the 5G network architecture to enable service deliveries via open Application Programming Interfaces (APIs) and move the network core towards an all Internet Protocol (IP), cloud based, and software driven telecommunications network. The SDN controller can work with, or take the place of, Policy and Charging Rules Function (PCRF) network elements so that policies such as quality of service and traffic management and routing can be synchronized and managed end to end.

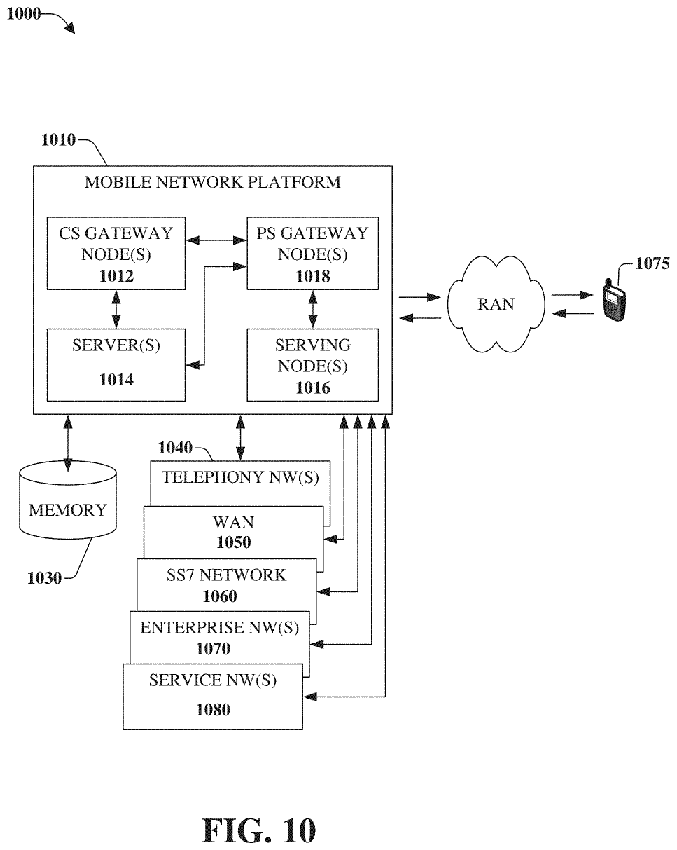

FIG. 10 presents an example embodiment 1000 of a mobile network platform 1010 that can be utilized implement and exploit one or more aspects of the disclosed subject matter described herein. Generally, wireless network platform 1010 can include components, e.g., nodes, gateways, interfaces, servers, or disparate platforms, that facilitate both Packet-Switched (PS) (e.g., Internet Protocol (IP), frame relay, Asynchronous Transfer Mode (ATM) and Circuit-Switched (CS) traffic (e.g., voice and data), as well as control generation for networked wireless telecommunication. As a non-limiting example, wireless network platform 1010 can be included in telecommunications carrier networks and can be considered carrier-side components as discussed elsewhere herein. Mobile network platform 1010 includes CS gateway node(s) 1012 which can interface CS traffic received from legacy networks such as telephony network(s) 1040 (e.g., Public Switched Telephone Network (PSTN), or Public Land Mobile Network (PLMN)) or a Signaling System #7 (SS7) network 1060. Circuit switched gateway node(s) 1012 can authorize and authenticate traffic (e.g., voice) arising from such networks. Additionally, CS gateway node(s) 1012 can access mobility, or roaming, data generated through SS7 network 1060; for instance, mobility data stored in a visited location register (VLR), which can reside in memory 1030. Moreover, CS gateway node(s) 1012 interfaces CS-based traffic and signaling and PS gateway node(s) 1018. As an example, in a 3GPP UMTS network, CS gateway node(s) 1012 can be realized at least in part in gateway GPRS support node(s) (GGSN). It should be appreciated that functionality and specific operation of CS gateway node(s) 1012, PS gateway node(s) 1018, and serving node(s) 1016, is provided and dictated by radio technology(ies) utilized by mobile network platform 1010 for telecommunication. Mobile network platform 1010 can also include the MMEs, HSS/PCRFs, SGWs, and PGWs disclosed herein.

In addition to receiving and processing CS-switched traffic and signaling, PS gateway node(s) 1018 can authorize and authenticate PS-based data sessions with served mobile devices. Data sessions can include traffic, or content(s), exchanged with networks external to the wireless network platform 1010, like Wide Area Network(s) (WANs) 1050, enterprise network(s) 1070, and service network(s) 1080, which can be embodied in Local Area Network(s) (LANs), can also be interfaced with mobile network platform 1010 through PS gateway node(s) 1018. It is to be noted that WANs 1050 and enterprise network(s) 1070 can embody, at least in part, a service network(s) such as IP multimedia subsystem (IMS). Based on radio technology layer(s) available in technology resource(s) 1017, packet-switched gateway node(s) 1018 can generate packet data protocol contexts when a data session is established; other data structures that facilitate routing of packetized data also can be generated. To that end, in an aspect, PS gateway node(s) 1018 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1000, wireless network platform 1010 also includes serving node(s) 1016 that, based upon available radio technology layer(s) within technology resource(s) 1017, convey the various packetized flows of data streams received through PS gateway node(s) 1018. It is to be noted that for technology resource(s) 1017 that rely primarily on CS communication, server node(s) can deliver traffic without reliance on PS gateway node(s) 1018; for example, server node(s) can embody at least in part a mobile switching center. As an example, in a 3GPP UMTS network, serving node(s) 1016 can be embodied in serving GPRS Support Node(s) (SGSN).

For radio technologies that exploit packetized communication, server(s) 1014 in wireless network platform 1010 can execute numerous applications that can generate multiple disparate packetized data streams or flows, and manage (e.g., schedule, queue, format, and so on) such flows. Such application(s) can include add-on features to standard services (for example, provisioning, billing, user support, and so forth) provided by wireless network platform 1010. Data streams (e.g., content(s) that are part of a voice call or data session) can be conveyed to PS gateway node(s) 1018 for authorization/authentication and initiation of a data session, and to serving node(s) 1016 for communication thereafter. In addition to application server, server(s) 1014 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1010 to ensure network's operation and data integrity in addition to authorization and authentication procedures that CS gateway node(s) 1012 and PS gateway node(s) 1018 can enact. Moreover, provisioning server(s) can provision services from external network(s) like networks operated by a disparate service provider; for instance, WAN 1050 or Global Positioning System (GPS) network(s) (not shown). Provisioning server(s) can also provision coverage through networks associated to wireless network platform 1010 (e.g., deployed and operated by the same service provider), such as femto-cell network(s) (not shown) that enhance wireless service coverage within indoor confined spaces and offload RAN resources in order to enhance subscriber service experience within a home or business environment by way of UE 1075.

It is to be noted that server(s) 1014 can include one or more processors configured to confer at least in part the functionality of macro network platform 1010. To that end, the one or more processor can execute code instructions stored in memory 1030, for example. It should be appreciated that server(s) 1014 can include a content manager 1015, which operates in substantially the same manner as described hereinbefore.

In example embodiment 1000, memory 1030 can store information related to operation of wireless network platform 1010. Other operational information can include provisioning information of mobile devices served through wireless network platform 1010, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1030 can also store information from at least one of telephony network(s) 1040, WAN 1050, enterprise network(s) 1070, or SS7 network 1060. In an aspect, memory 1030 can be, for example, accessed as part of a data store component or as a remotely connected memory store.

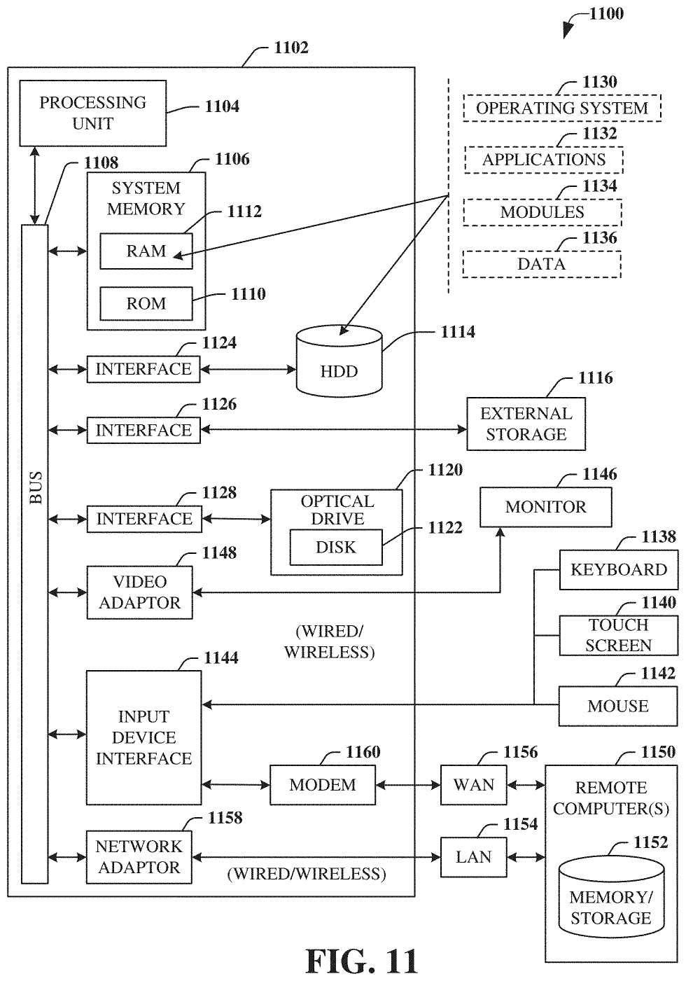

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, Random Access Memory (RAM), Read Only Memory (ROM), Electrically Erasable Programmable Read Only Memory (EEPROM), flash memory or other memory technology, Compact Disk Read Only Memory (CD-ROM), Digital Versatile Disk (DVD), Blu-ray Disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, Erasable Programmable Read Only Memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an internal HDD 1114. The internal HDD 1114, external storage device(s) 1116 and optical disk drive 1120 can be connected to the system bus 1108 by an HDD interface 1124, an external storage interface 1126 and an optical drive interface 1128, respectively. The HDD interface 1124 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally include emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can include one virtual machine (VM) of multiple VMs hosted at computer 1102. Furthermore, operating system 1130 can provide runtime environments, such as the Java runtime environment or the .NET framework, for application programs 1132. Runtime environments are consistent execution environments that allow application programs 1132 to run on any operating system that includes the runtime environment. Similarly, operating system 1130 can support containers, and application programs 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1160, and a pointing device, such as a mouse 1162. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1164 that can be coupled to the system bus 1108, but can be connected by other interfaces, such as a parallel port, an IEEE 1094 serial port, a game port, a USB port, an IR interface, a BLUETOOTH® interface, etc.

A monitor 1166 or other type of display device can be also connected to the system bus 1108 via an interface, such as a video adapter 1168. In addition to the monitor 1166, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1180 or can be connected to a communications server on the WAN 1156 via other means for establishing communications over the WAN 1156, such as by way of the Internet. The modem 1180, which can be internal or external and a wired or wireless device, can be connected to the system bus 1108 via the input device interface 1164. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1180, respectively. Upon connecting the computer 1102 to an associated cloud storage system, the external storage interface 1126 can, with the aid of the adapter 1158 and/or modem 1180, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

An aspect of 5G, which differentiates from previous 4G systems, is the use of NR. NR architecture can be designed to support multiple deployment cases for independent configuration of resources used for RACH procedures. Since the NR can provide additional services than those provided by LTE, efficiencies can be generated by leveraging the pros and cons of LTE and NR to facilitate the interplay between LTE and NR, as discussed herein.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments. The term “include” can be used interchangeably with the term “comprise,” or variants thereof.

As used in this disclosure, in some embodiments, the terms “component,” “system,” “interface,” and the like are intended to refer to, or include, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, Wireless Fidelity (Wi-Fi), Global System For Mobile Communications (GSM), Universal Mobile Telecommunications System (UMTS), Worldwide Interoperability For Microwave Access (WiMAX), enhanced General Packet Radio Service (enhanced GPRS), Third Generation Partnership Project (3GPP) long term evolution (LTE), Third Generation Partnership Project 2 (3GPP2) Ultra Mobile Broadband (UMB), high speed packet access (HSPA), Z-Wave, Zigbee and other 802.XX wireless technologies and/or legacy telecommunication technologies.

The various aspects described herein can relate to New Radio (NR), which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, a UMTS implementation, and/or an LTE implementation as the techniques can also be applied in 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

As used herein, “5G” can also be referred to as NR access. Accordingly, systems, methods, and/or machine-readable storage media for facilitating link adaptation of downlink control channel for 5G systems are desired. As used herein, one or more aspects of a 5G network can include, but is not limited to, data rates of several tens of megabits per second (Mbps) supported for tens of thousands of users; at least one gigabit per second (Gbps) to be offered simultaneously to tens of users (e.g., tens of workers on the same office floor); several hundreds of thousands of simultaneous connections supported for massive sensor deployments; spectral efficiency significantly enhanced compared to 4G; improvement in coverage relative to 4G; signaling efficiency enhanced compared to 4G; and/or latency significantly reduced compared to LTE.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
identifying, by a system comprising a memory and a processor, a first portion of a first traversal route grid associated with a first object and a second portion of a second traversal route grid associated with a second object, wherein the identifying is based on the first portion and the second portion being determined to be overlapping portions during a same time period; and
linking, by the system, during the same time period, a first movement of the first object and a second movement of the second object across the overlapping portions.

2. The method of claim 1, wherein the linking comprises orientating the first object and the second object according to a configuration that facilitates energy conservation.

3. The method of claim 2, wherein the energy conservation is a mitigation of a first amount of energy expended for the first movement of the first object.

4. The method of claim 1, wherein the linking comprises orienting the first object and the second object according to a configuration that facilitates a reduction in an amount of time for the first movement and the second movement across the overlapping portions.

5. The method of claim 1, wherein the linking comprises:
determining, by the system, a first source location and a first destination location of the first object and a second source location and a second destination location of the second object; and
determining, by the system, that the first object and the second object should be linked based on a match between a first route traveled by the first object from the first source location to the first destination location and a second route traveled by the second object from the second source location to the second destination location.

6. The method of claim 1, wherein the first traversal route grid and the second traversal route grid are represented as a three-dimensional space and a time element.

7. The method of claim 1, wherein the first traversal route grid represents first travel of the first object between a first source node and a first target node and comprises first multiple alternative route segments between the first source node and the first target node, and wherein the second traversal route grid represents second travel of the second object between a second source node and a second target node and comprises second multiple alternative route segments between the second source node and the second target node.

8. The method of claim 1, wherein the first object is an autonomous vehicle, and wherein the method further comprises:
creating, by the system, the overlapping portions based on a modification to at least a portion of the first traversal route grid for the first object based on a type of the autonomous vehicle.

9. The method of claim 8, wherein the identifying comprises:
selecting a first path based on the autonomous vehicle being determined to be an electric-powered vehicle;
selecting a second path based on the autonomous vehicle being determined to be a gas-powered vehicle; and
selecting a third path based on the autonomous vehicle being determined to be a hybrid-powered vehicle.

10. The method of claim 1, wherein the first object and the second object are physical objects moving in a three-dimensional space.

11. The method of claim 1, wherein the first object and the second object are configured to operate according to a fifth generation communication protocol.

12. A system, comprising:
a processor; and
a memory that stores executable instructions that, when executed by the processor, facilitate performance of operations, comprising:
determining a first route path between a first source location of a first movable object and a first destination location of the first movable object, wherein the first route path comprises a first group of alternative route paths;
determining a second route path between a second source location of a second movable object and a second destination location of the second movable object, wherein the second route path comprises a second group of alternative route paths; and
selecting a first alternative route path of the first group of alternative route paths for the first movable object based on the first alternative route path coinciding, during a defined time interval, with a second alternative route path of the second group of alternative route paths for the second movable object.

13. The system of claim 12, wherein the operations further comprise:
treating the first movable object and the second movable object as an object group during the defined time interval and while the first movable object and the second movable object are traversing the first alternative route path and the second alternative route path.

14. The system of claim 12, wherein the operations further comprise reducing an amount of energy expended for a movement of the first movable object based on an orientation of the first movable object relative to the second movable object.

15. The system of claim 12, wherein the first movable object is classified as a type of device capable of horizontal movement and vertical movement.

16. The system of claim 12, wherein the first movable object is configured to operate according to a fifth generation communication protocol.

17. The system of claim 12, wherein the first movable object is configured to operate according to a sixth generation communication protocol.

18. A non-transitory machine-readable medium, comprising executable instructions that, when executed by a processor, facilitate performance of operations, comprising:
defining a first route for a first user equipment and a second route for a second user equipment, wherein a first starting position and a first ending position of the first user equipment is different from a second starting position and a second ending position of the second user equipment;
identifying a first segment of the first route that overlaps with a second segment of the second route during a same time interval, resulting in an overlapping segment; and
facilitating movement of the first user equipment and the second user equipment to occur as a single unit during the overlapping segment.

19. The non-transitory machine-readable medium of claim 18, wherein the facilitating comprises reducing an amount of time taken by the first user equipment and the second user equipment to traverse the overlapping segment as compared to the first user equipment and the second user equipment moving independently over the overlapping segment.

20. The non-transitory machine-readable medium of claim 18, wherein the first user equipment and the second user equipment are configured to operate according to a sixth generation communication protocol.
